(19) United States
(12) Patent Application Publication
(10) Pub. No.: US 2011/0170309 A1
(43) Pub. Date: Jul. 14, 2011

(54) REFLECTOR IN A LIGHTING APPARATUS OF A MOTOR VEHICLE

(75) Inventors: Berthold Doring, Werl-Buderich (DE); Gerhard Rotgeri, Geseke (DE)

(73) Assignee: Hella KGaA, Lippstadt (DE)

(21) Appl. No.: 13/119,136

(22) PCT Filed: Sep. 14, 2009
(86) PCT No.: PCT/EP09/61850

§ 371 Date: Mar. 15, 2011

(30) Foreign Application Priority Data
Sep. 16, 2008 (DE) 102007017079.5

(51) Int. Cl. F21V 7/00; B29D 11/00

(52) U.S. Cl. 362/516; 264/1.9

(57) ABSTRACT

The present invention relates to a reflector in a lighting apparatus of a motor vehicle comprising a reflecting surface and a pot-shaped metal body carrying the reflecting surface, wherein the reflecting surface is attached to an inner side of the body, wherein at least the reflecting surface of the reflector is comprised of an element injection molded from a plastic material and attached to the metal body of the reflector, and wherein the metal body is shaped such that the injection molded element is connected to said metal body in a stationary manner.

The present invention relates to a reflector in a lighting apparatus of a motor vehicle, comprising a reflecting surface and a pot-shaped metal body carrying the reflecting surface, wherein the reflecting surface is attached to an inner face of the body.

The invention further relates to a method of manufacturing a reflector, whereby a metal body is formed, and an apparatus for implementing the method.

It is generally known from the prior art how to make metal reflectors for vehicle headlamps from sheet metal or by a die casting method. A smooth surface is produced by applying a smoothing varnish to the inner face of the metal reflector. To obtain a reflecting surface, the coat of varnish is vapor-coated afterwards.

Subsequently published German patent application 10 2007 017 079.5 further reveals a reflector for vehicle headlamps comprising a metal body carrying the reflecting surface such that a plurality of connecting elements is injection molded to a rear side of said metal body. The connecting elements are made of a plastic material and designed to connect the reflector to an adjacent functional component such as a light source or a vehicle body.

Disadvantages of the aforesaid solution are that the inner face of the reflector is difficult to varnish and that adding a fine structure to the reflecting surface is more complicated.

Thus, the purpose of the present invention is to further develop a metal reflector such that producing the reflecting surface is cost effective while improving the smoothness of said reflecting surface.

To accomplish this task, the invention, in conjunction with the introductory clause of claim 1, is characterized in that at least the reflecting surface of the reflector is provided by an element injection molded from a plastic material and attached to the metal reflector body, and that the shape of the metal body provides for holding the attached injection molded element in a stationary position on said metal body.

A particular advantage of the invention is that the reflector is built as a component consisting of two composite materials. The metal body carries the reflecting surface while stabilizing the reflector. It may also serve as a heat sink for dissipating heat and/or as a shield against electromagnetic interference. Since the reflecting surface of the reflector is not provided by the actual metal body but by the injection molded element attached to it, the tolerances on the shape of the metal body are under less strict requirements than those demanded by other solutions known from the prior art. For this reason, the metal body can be manufactured in a particularly cost effective manner. An advantageous aspect is that the shape of the reflecting surface provided by the injection molded element attached can be independent of the pot-shaped body, thereby allowing an optimized design of the reflecting surface. For example, a fine structure may be added to some of the reflecting surface dedicated to improving the reflector's photometric properties. The invention benefits from the shape of the injection molded element or the way it is connected to the reflector not being subject to the constraints and limitations of the process of manufacturing the metal body such that the reflecting surface can be produced irrespective of the technical limitations of a sheet metal forming or metal die casting process.

Moreover, given the surface of the injection molded plastic body is sufficiently smooth, there is no need for a coat of varnish to act as a base of the vaporized reflecting surface.

In a preferred embodiment of the invention, the metal body has a localizing area allocated to a collar ring protruding from an outer face in the socket area of the metal body. The injection molded element is back molded to the collar ring to make a stationary connection to the metal body. This is producing an advantageous defined connection area in which the attached injection molded element connects to the body in a stationary manner. In the forming process, both the localizing area on the collar ring and the body can be shaped together in a single working step.

In a further development of the invention, the metal body may comprise a recess for providing the localizing area. Injecting the molding compound through the recess and molding the injection molded element on to a section of the recess edge allocated to the outer face of the metal body will connect said element to the body in a stationary manner. The recess provides a defined localizing area that the molding compound can be injected through in order to attach the injection molded element to the metal body. An advantageous option is to add the recess to the body as said body is being formed.

In a further development of the invention, a localizing area on the metal body may be formed like a local bulge which is filled with molding compound to connect the attached injection molded element to the metal body in a stationary manner. The local bulge may be formed in the injection molding tool by applying a high spraying pressure when molding the injection molded element on to the inner face of the body. Providing a local bulge to make up the localizing area is advantageous in that a defined connection area is formed that plastic material may be molded on to form the injection molded element. Inasmuch as the local bulge is formed while injecting the molding compound onto the inner face of the body, there is the advantage of forming the localizing area together with the injection molded element in a single working step.

In a further development of the invention, the injection molded element has a molded section provided as a joining section for connecting the reflector to another functional component. The advantageous effect is that a joining section can be molded onto the body that is independent of the reflector's pot-shaped body such that an optimal mounting or positioning of the reflector in a headlamp housing or on a part of the vehicle body is ensured. Moreover, the joining section can be shaped in a way that allows a light source to be connected to the reflector at an accurate position. The shape of the joining section may be variable and take heed of installation space restrictions, the advantage being that a space-saving arrangement of the reflector in a vehicle headlamp is achieved.

In a further development of the invention, a metal mount for light sources is provided in a socket area of the body such that said mount encompasses the joining element to provide the socket area with EMC contacts and an EMC shield. EMC shielding of the socket area has the advantage of operating a xenon light source, for example, without any need for corresponding further protective measures.

To accomplish its task, the inventive method, in conjunction with the introductory clause of claim 11, is characterized in that a reflecting surface is afterwards applied by injecting a molding compound onto an inner face of the body such that the reflecting surface connects to the body in a stationary manner.

The particular advantage of the inventive method is that it produces and firmly joins a reflecting surface to a pot-shaped metal body of the reflector at the same time. An advantageous reflecting surface has fine structures to provide an optimized photometric surface. At the same time, the metal body can be calibrated in the injection molding tool by the pressure at which the molding compound is injected. Well calculated “inflating” of the metal body by the injection pressure in the injection molding tool may also compensate for the difference in shrinkage of the metal body on the one hand and the injected plastic material on the other.

According to a further development of the inventive method, some of the inner face of the metal body is reshaped by the pressure of the molding compound injected into the molding cavity such that a local bulge ensues which acts as a receptacle of some of the molding compound for anchoring the injection molded reflecting surface to the metal body. Forming the local bulge during the injection molding process by the pressure applied to the molding compound first of all simplifies the process of forming the metal body. Moreover, the bulge is formed at a single step immanent to the injection molding process, as it were, which causes the injection molded element to be attached to the metal body in an economically very efficient manner.

According to a further development of the method, the metal body is shaped and a molding cavity is formed such that a joining section making an integral whole with the reflecting surface and intended to connect the reflector to another functional component is molded onto an outer face of the metal body. The advantage of said further development is that it produces joining sections which are firmly connected to the metal body and the reflecting surface and perfectly meet strictest physical and/or chemical requirements of mounting the reflector to adjacent functional components. Said joining sections can be molded onto a precise position on the body, thereby providing a connection of particularly low tolerance between the reflector and parts of the vehicle body or a light source, for example.

For other advantages of the invention refer to the other dependent claims.

The text below explains some embodiments of the invention with reference to the drawings.

The following is shown:

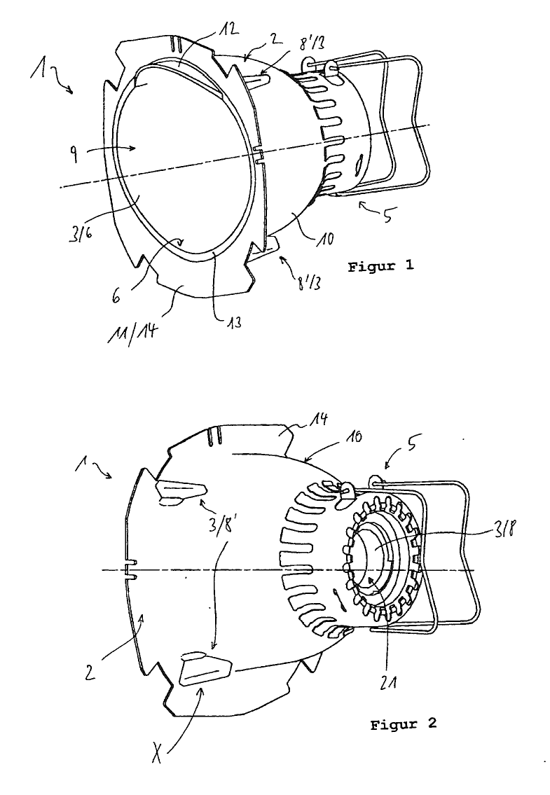

FIG. 1 a perspective front view of a reflector,

FIG. 2 a perspective rear view of the reflector shown in FIG. 1,

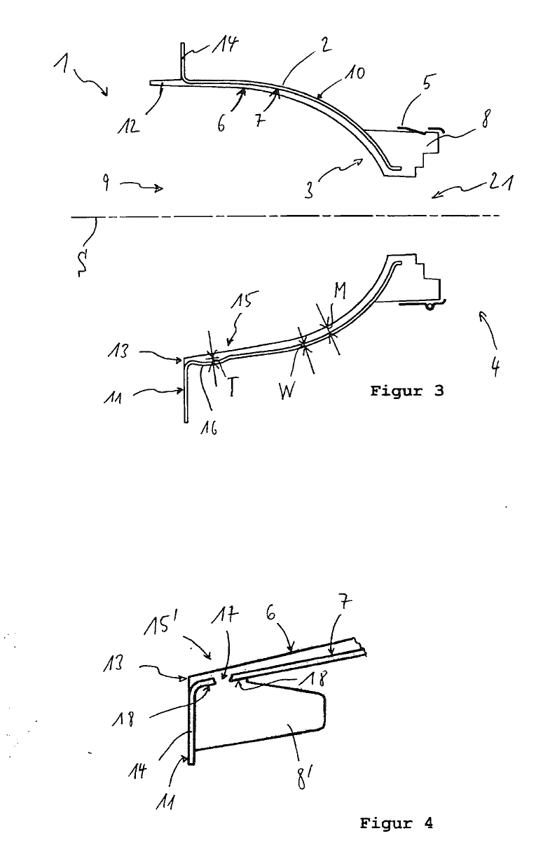

FIG. 3 a vertical section through the reflector shown in FIG. 1,

FIG. 4 a magnified sectional view of a joining section X of the reflector shown in FIG. 1,

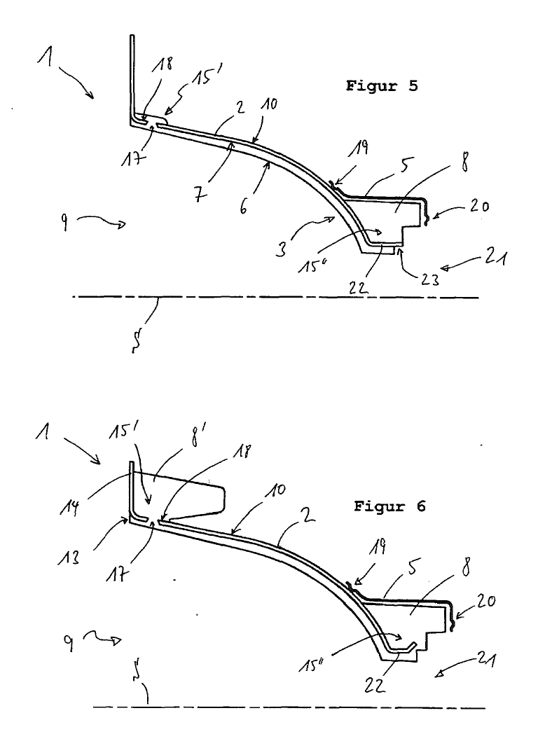

FIG. 5 a vertical section through a reflector according to a second embodiment, and

FIG. 6 a vertical section through a reflector according to a third embodiment.

A reflector 1 in a lighting apparatus of a motor vehicle mainly comprises a pot-shaped body 2, an injection molded element 3 attached to the pot-shaped body 2, and a mount for light sources 5 allocated to a socket area 4 of said body 2. The injection molded element 3 provides a reflecting surface 6 two-dimensionally arranged on an inner face 7 of the body 2. The lighting apparatus may serve as a headlamp or a signal lamp.

Apart from the reflecting surface 6, the injection molded element 3 has further molded sections provided as joining sections 8, 8′ for connecting the reflector 1 to other functional components not shown in the Figures. The joining section 8 in the socket area 4 of the reflector 1 is shaped such that it provides an opening 21 that a light source not shown in the Figures can be placed in and mounted on the reflector 1 at a precise and coaxial position in the body 2.

The joining sections 8′ located in a part of the outer face 10 of the body 2 adjacent to a large front opening 9 of the reflector 1 are shaped such that the reflector 1 can be attached to a functional component (not shown in the Figures) of the lighting apparatus or a carrying part of the vehicle body. In this arrangement, the joining sections 8′ protrude towards the back from a flange 14 making up and protruding from a front edge 11 of the metal body 2 in radial direction.

The body 2 may be made of a sheet metal material (steel sheet, metal sheet with a roughened surface, punched sheet, perforated sheet) or a metal mesh with a plurality of holes/openings or another metal material. The injection molded element 3 may be made of a thermoplastic or thermosetting plastic material. The metal body and the injection molded element attached to it may have an equivalent coefficient of thermal expansion, for example by pairing aluminum/polyphenylene sulfide (PPS) or steel/bulk molding compound (BMC, fiber-reinforced plastic).

The reflecting surface 6 made up of the injection molded element 3 mainly follows the pot-shaped outline of the metal body 2 and is connected to the inner face 7 of the body 2 in a two-dimensional arrangement. The radial thickness M of the reflecting surface 6 is equivalent to 0.5 to 5 times the wall thickness W of the pot-shaped body 2. After injection molding, the reflecting surface 6 may be smooth such that there is no need for a priming coat of varnish prior to vapor-coating it. Furthermore, a fine structure may be added to some of the reflecting surface 6 dedicated to particularly enhancing the optical properties of the reflector 1.

With reference to the mounting position of the reflector 1, there is a projecting end 12 protruding from the reflecting surface 6 along the top area of the injection molded element 3 such that the injection molded element 3 projects over the front edge 11 of the metal body 2. A front edge section 13 bordering on the reflecting surface 6 and adjoining both sides of the projecting end 12 is flush with the flange 14 making up the front edge 11 of the body 2.

With reference to the mounting position of the reflector 1, the metal body 2 has a local bulge 16 in the localizing area 15 along its bottom edge that is near the front edge 11. Injecting molding compound into the local bulge 16 joins the injection molded element 3 to the metal body 2 in a stationary manner. By virtue of the depth T of the local bulge 16, the injection molded element 3 is secured against both turning around a photometric axis of symmetry S and against slipping out of the large front opening 9 of the reflector 1.

A recess 17 in the metal body 2 is provided for in the joining area 8′ to produce a localizing area 15′. Molding compound is injected through the recess 17 in order to fix the injection molded element 3 in its position with reference to the metal body 2 as well as to provide the joining section 8′. At the same time, molding compound is injected onto the outer face 10 of the metal body 2 or, more precisely, onto the section of the recess edge 18 allocated to the recess 17. This is securing the injection molded element 3 against turning or slipping out.

According to an alternative embodiment of the reflector 1 shown in FIG. 5, molding compound is injected through the recess 17 and the injection molded element 3 is molded onto the outer section of the recess edge 18. This is doing without forming a joining section on the outer face 10 of the reflector 1 allocated to the recess 17.

In the socket area 4, the joining section 8 is encompassed by a mount for light sources 5 made of sheet metal or other material. The mount for light sources 5 can be removed and installed such that an outer edge section 19 contact the outer face 10 of the metal body 2 such that the metal body 2 and the mount for light sources 5 establish an electrically conductive connection. An inner edge section 20 of the mount for light sources 5 is designed such that it produces an opening 21 provided for placing a light source not shown in the Figures in or for allowing it to contact the joining section 8 intended to hold said light source.

In order to provide an electrically conductive connection between the light source not shown in the Figures and the metal body 2, only some of the socket area 4 of the metal body 2 is encompassed by the injection molded element 3. This is producing a bushing 23 for providing an EMC contact or EMC shield for the metal body 2, the mount for lighting sources 5, and the light source not shown in the Figures.

According to an alternative embodiment shown in FIG. 6, the metal body 2 has a recess 17 that adjoins a joining section 8′ located on the outer face of the metal body 2. As has been mentioned before, a joining section for holding a light source not shown in the Figures and encompassed by the mount for light sources 5 is located in the socket area 4. In order to provide a localizing area 15″ in the socket area 4, a collar ring 22 bent in coaxial direction around the body 2 and shaped like a boomerang adjoins the body 2 such that said collar ring protrudes from the body's 2 photometric axis of symmetry S mainly in axial direction towards the back. Just like the inner face 7 and a part of the outer face 10 of the body 2 allocated to the socket area 4, said collar ring 22 is encompassed by the injection molded element 3. This is forming an undercut to provide a stationary connection between the metal body 2 and the injection molded element 3 as well as a comparatively large contact surface between the injection molded element 3 and the body 2 within the localizing area 15″.

To injection mold the element 3, the body 2 made of a metal material is placed in a molding cavity of an injection molding tool and aligned with reference to said injection molding tool. At a single working step, the molding compound is fed to the molding cavity while forming the reflecting surface 6 on the inner face 4 of the metal body 2, filling the local bulge 16, injecting compound through the recess 17, and forming the joining sections 8, 8′. As the joining sections 8, 8′ are formed, compound is injected onto the outer section of the recess edge 18 and behind the collar ring 22 in socket area 4. One or several nozzles may be assigned to the injection molding tool, in order to control the amount of molding compound applied as the case requires. Sliding tool gates may set the shape given to the joining sections 8, 8′.

During the injection molding process, the metal body 2 can be aligned or calibrated by the pressure at which the molding compound is injected. Also, the metal body 2 can be inflated, that is to say enlarged, in a defined way in order to compensate for differences in shrinkage between the body 2 and the injected plastic material. This may involve putting the metal body 2 under enough pressure of molding compound injection to push it against the wall of the injection molding tool.

The local bulge 16 may be integrated in the metal body 2 as said body 2 is being formed. An alternative approach is to form the local bulge 16 during the injection molding process by injecting the molding compound under high pressure onto the metal body 2 and by leaving a cavity in the tool on the outer face 10 of the body 2 allocated to the localizing area 15 such that said cavity corresponds to the outer geometry of the bulge 16.

When injection molding has provided a stationary connection between the body 2 and the injection molded element 3, the reflector 1 can be removed from the tool. Now a reflecting coating can be applied to the reflecting surface 6 of the reflector 1 by way of vapor-coating or other suitable method.

As an alternative to the aforesaid way and in order to obtain a particularly smooth surface, the reflecting surface 6 may be varnished prior to vapor-coating it.

The injection molding tool may have retrofit kits for molding differently shaped joining sections 8 that different bulb sockets can be placed in. This is one way of manufacturing a plurality of reflector 1 variants for holding different bulb sockets just by changing retrofit kits.

During the injection molding process, it is also possible to add a fine structure to the reflecting surface 4. This is intended to improve the photometric properties of the reflector.

According to an embodiment of the invention not shown in the Figures, the body 2 may also be made up of several body parts, wherein the molded-on joining elements 8, 8′ ensure that the body parts are attached in relation to one another in the localizing areas 15, 15′, 15″.

An alternative design provides for a body 2 consisting of several parts, wherein parts of the body exposed to higher heat loads may be made of a metal material, whereas parts of the body exposed to lower heat loads may be made of a thermosetting or a thermoplastic material.

The reflector is of course suitable for use in other than vehicle headlamps.

According to an embodiment of the invention not shown in the Figures, different properties of the injection molding tool can be obtained by using at least two different plastic materials. Options worth considering include laminated plastic materials first molten and then injected into the molding cavity of the injection molding tool one by one. Injection of plastic materials can be delayed or directed at different areas of the molding cavity. Another possibility is to inject different plastic materials at different pressures.

1. A reflector in a lighting apparatus of a motor vehicle comprising:
a reflecting surface and a pot-shaped metal body carrying the reflecting surface, wherein the reflecting surface is attached to an inner side of the body;
at least the reflecting surface of the reflector is comprised of an element injection molded from a plastic material and attached to the metal body of the reflector; and
the metal body being shaped such that the injection molded element is attached to it in a stationary position when connected to the metal body.

2. The reflector of claim 2, characterized in that the injection molded element is attached to and held in its position on the metal body by being molded on to a localizing area of the metal body.

3. The reflector of claim 1, characterized in that the localizing area is arranged along a collar ring which protrudes from an outer face of the metal body such that the injection molded element can be back molded for attachment to the collar ring.

4. The reflector of claim 1, characterized in that the metal body has a recess to make a localizing area such that the injection molded element is attached by injection through the recess on one side and molding it on to an edge section of the recess allocated to the outer face of the metal body on the other.

5. The reflector of claim 1, characterized in that the metal body has a local bulge to make the localizing area such that the injection molded element is attached to the metal body by filling the bulge with compound to secure the injection molded element in its position.

6. The reflector of claim 5, characterized in that the local bulge can be formed in an injection molding tool by applying high injection pressure when molding the injection molded element on to the inner face of the body.

7. The reflector of claim 1, characterized in that a molded section of the injection molded element is shaped to make a joining section for connecting the reflector to another functional component.

8. The reflector of claim 7, characterized in that at least some of the joining section is allocated to the outer face of the metal body.

9. The reflector of claim 1, characterized in that the joining section encloses only a part of the metal body in some of its socket area such that a conductive metal bushing is made to provide an EMC contact or EMC shield for the metal body.

10. The reflector of claim 1, characterized in that a metal mount for light sources is applied to the socket area of the body such that said metal mount for light sources encompasses the joining section and such that it provides an EMC contact and/or EMC shield for said socket area.

11. A method of manufacturing a reflector in a lightning apparatus of a motor vehicle comprising:
a reflecting surface and a pot-shaped metal body carrying the reflecting surface, wherein the reflecting surface is attached to an inner side of the body;
at least the reflecting surface of the reflector is comprised of an element injection molded from a plastic material and attached to the metal body of the reflector; and
the metal body being shaped such that the injection molded element is attached to it in a stationary position when connected to the metal body;
whereby a metal body is formed and a reflecting surface is afterwards formed by injecting molding compound on to an inner face of the body such that the reflecting surface makes a stationary juncture with the body.

12. The method of claim 11, characterized in that some of the inner face of the metal body is reshaped by the pressure of the molding compound injected into a molding cavity such that a local bulge ensues which acts as a receptacle of some of the molding compound for anchoring the injection molded reflecting surface to the metal body.

13. The method of claim 11, characterized in that the metal body is shaped and a molding cavity is formed such that a joining section making an integral whole with the reflecting surface and intended to connect the reflector to another functional component is molded on to an outer face of the metal body.

14. The method of claim 11, characterized in that a reflecting coating is applied to the reflecting surface.

15. The method of claim 11, characterized in that at least two plastic materials are injected into the molding cavity at different times or into different places or at different injection pressures.
